(19) United States
(12) Patent Application Publication
(10) Pub. No.: US 2004/0264190 A1
(43) Pub. Date: Dec. 30, 2004

(54) Light source module structure for CIS module

(75) Inventors: Ling Ta Su, Chiayi City (TW); I Wang Wen, Banciao City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Creative Sensor Inc., Sindian City (TW)

(21) Appl. No.: 10/819,431

(22) Filed: Apr. 7, 2004

(30) Foreign Application Priority Data
Jun. 24, 2003 (TW) 092117181

(51) Int. Cl. F21V 7/04

(52) U.S. Cl. 362/257

(57) ABSTRACT

A light source module structure for a CIS module of a scanner, a multi-function printer (MFP) or a copy machine is provided. The light source module structure includes a housing having a first circuit board therein; a light-sensing element disposed on the first circuit board and electrically connected to the first circuit board; a lens disposed in the housing and being parallel to the light-sensing element; and at least one organic electro luminescent element integration disposed in the housing to provide a light source.

### FIELD OF THE INVENTION

This invention relates to a light source module structure for a CIS module of a scanner, a multi-function printer (MFP) or a copy machine, and more particularly to a light source module structure for a scanner having a contact image sensor (CIS).

### BACKGROUND OF THE INVENTION

In operation of a scanner, a multi-function printer (MFP) or a copy machine, light is emitted from a source to a object, then passes through the lens, and the light is focused on and received by a charge-couple device (CCD) or a complementary metal oxide semiconductor (CMOS). The light signal is transferred into electric signal by such light-sensing component, so that data of analog or digital pixels are produced. During the scanning, the intensity of the light reflected from different areas of the scanned object is detected by the CCD. The low density of light is reflected from a darker area of the scanned object and the high density of light is reflected from a lighter area of the scanned object. Since the reflected light is transferred into analog or digital data by the CCD, the electric signals are proportional to the light density. Then, the electric signals are recombined into a image file by a text processing software or an image software compatible for the scanner.

The performance of a CIS system depends on the light-controlling technology, so that the quality of the optical module is very important for the performance of the scanner, a multi-function printer (MFP) or a copy machine.

Presently, the contact image sensor is widely used in a scanner, a multi-function printer (MFP) or a copy machine, wherein the contact image sensor is an assembly of a light source, a rod lens, a sensing substrate and a housing. In conventional fabrication of the light source, the light source is made from a cold cathode fluorescent lamp (CCFL); however, the market share of the assembled CIS module is quite small owing to the large volume of the light source, so that a light emitting diode or a LED array is provided to a light source in the prior art.

Please refer to FIG. 1(a) showing a light emitting diode as a light source structure in a scanner, a multi-function printer (MFP) or a copy machine according to the prior art. A light emitting diode 12 is disposed at one side of light source structure 10, and the light emitted from the light emitting diode 12 is introduced to another side of the light source structure 10 via a selguide 11. It means that the point light is transferred into the linear light by using the physical properties of the selguide to achieve light evenness. However, light evenness is dependent on the material and the fabrication quality of the selguide 11, and furthermore photo response non uniformity (PRNU) of the image is affected. Particularly, when the size of a scanner is larger and the distance between the light and the light emitting diode is longer, it is harder to control the luminance of the light as shown in FIG. 1(b). Although the light evenness is improved by changing the design of the selguide 11, the optimization is achieved only when repeated designs and tests are implemented, so that the conventional technologies are time-consuming and costing.

Please refer to FIG. 2 showing a light emitting diode array as a light source structure of a scanner, a multi-function printer (MFP) or a copy machine according to the prior art. A light source structure 20 includes a light emitting diode array 21, a rod lens 22, a circuit board 23 and a housing 24. In the embodiment of FIG. 2, the control of light luminance is improved by using an array of a plurality of light emitting diodes. However, there is still much space in the light emitting diode array 21, and for a CIS module of a scanner, a multi-function printer (MFP) or a copy machine requesting a higher resolution of an image, the image quality is significantly affected by unevenness of light reflected from the rod lens 22.

Therefore, the present invention provides a light source module structure for a scanner to overcome the disadvantages of the prior art described above.

### SUMMARY OF THE INVENTION

It is an aspect of the present invention to provide a light source module structure for a CIS module. According to the present invention, the light source module structure includes an organic electro luminescent element. Since the organic electro luminescent element is energy saving, easily fabricated and operated at wide range of temperature, and the organic electro luminescent element further has low cost, full color and a high reaction rate without viewing angles, so that uneven distribution of light emitted from a source of a light emitting diode can be eliminated.

In accordance with the aspect of the present invention, a light source module structure for a scanner is provided and includes a housing having a first circuit board therein; a light-sensing element disposed on the first circuit board and electrically connected to the first circuit board; a lens disposed in the housing and being parallel to the light-sensing element; and at least one organic electro luminescent element integration disposed in the housing to provide a light source; wherein light emitted from the light source is reflected from a scanned object to form a reflected light, and the reflected light is focused on the light-sensing element via the lens.

Preferably, the organic electro luminescent element integration is a small molecular organic light emitting diode integration.

Preferably, the organic electro luminescent element integration is a polymeric organic light emitting diode integration.

Preferably, the housing further has a transparent surface for the light and the reflected light to pass therethrough.

Preferably, the transparent surface is formed of glass.

Preferably, the light-sensing element is one selected from a group consisting of a charge-coupled device, a complementary metal oxide semiconductor and an element having an optical to electronic converting property.

Preferably, the light source provided by the organic electro luminescent element integration is a monochromatic light.

Preferably, the light source provided by the organic electro luminescent element integration is a light with primitive colors.

Preferably, the light source provided by the organic electro luminescent element integration has a pixel pattern having a random shape and a random arrangement.

Preferably, a plurality of organic electro luminescent element integrations are fabricated by a tiling technology to form a needed size.

Preferably, a plurality of organic electro luminescent element integrations are fabricated by an array technology to form a needed size.

Preferably, the organic electro luminescent element integration is connected to the first circuit board by one of a flexible print circuit and a connector.

Preferably, the organic electro luminescent element integration is disposed on a second circuit board in the housing, and a light-emitting mechanism of the organic electro luminescent element integration is controlled by the second circuit board.

Preferably, the second circuit board is connected to the first circuit board by one of a flexible print circuit and a connector.

Preferably, a substrate of the organic electro luminescent element integration is one selected from a group consisting of glass, plastics, metals and flexible films.

It is another aspect of the present invention to provide a CIS module of a scanner, a multi-function printer (MFP) or a copy machine including a housing having a first circuit board therein; a light-sensing element disposed on the first circuit board and electrically connected to the first circuit board; a lens disposed in the housing and being parallel to the light-sensing element; and at least one organic electro luminescent element integration disposed in the housing to provide a light source; wherein light emitted from the light source is reflected by a scanned object to form a reflected light, and then the reflected light is focused on the light-sensing element via the lens.

The above aspects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic view showing a light emitting diode as a light source structure in a scanner according to the prior art;

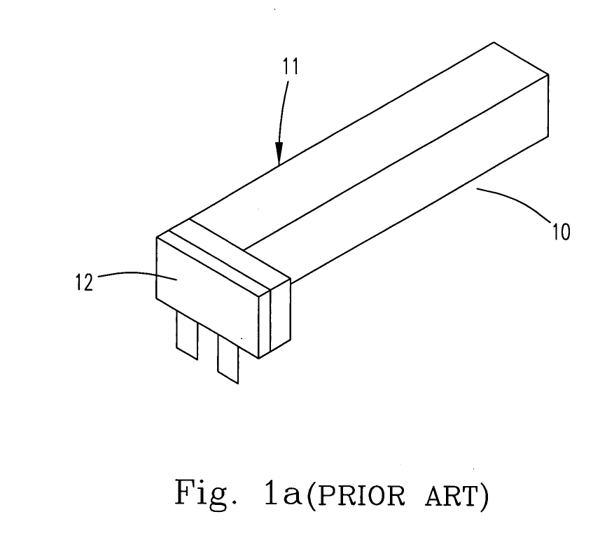

FIG. 1(b) is a schematic view showing a selguide according to FIG. 1(a);

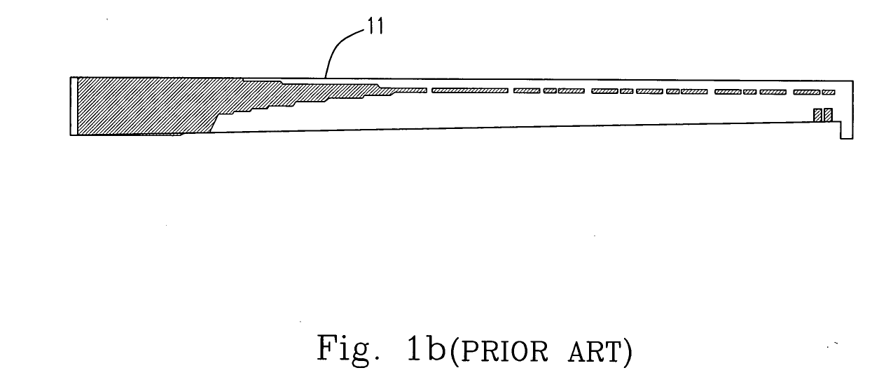

FIG. 2 is a schematic view showing a light emitting diode as a light source structure in a scanner according to the prior art;

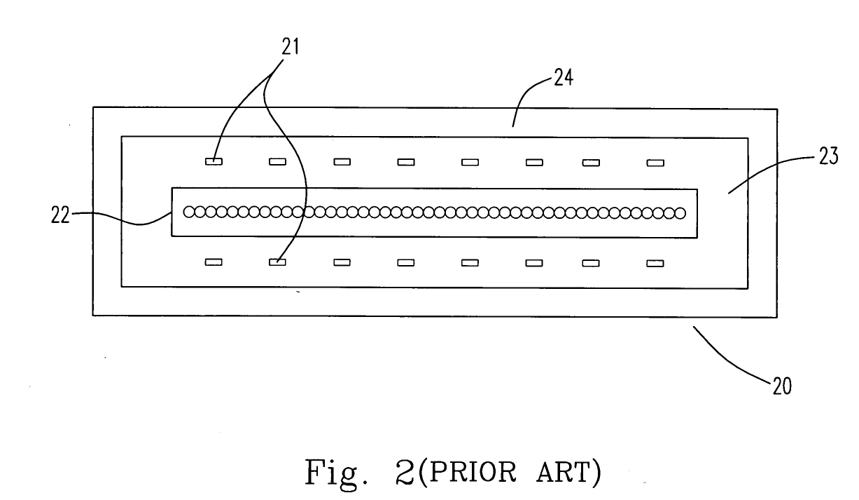

FIG. 3(a) is a schematic view showing a light source module structure according to a preferred embodiment of the present invention;

FIG. 3(b) a schematic view showing a light source module structure according to another preferred embodiment of the present invention;

FIG. 4 is a schematic view showing a top view of an organic electro luminescent element for providing a monochromatic light according to a preferred embodiment of the present invention; and

FIGS. 5(a)-(c) are schematic views showing pixel arrangements of an organic electro luminescent element providing a light with primitive colors according to a preferred embodiment of the present invention.

### DETAILED DESCRIPTION OF THE PREFERRED EMBODIMENT

The invention is described more specifically with reference to the following embodiments. It is to be noted that the following descriptions of preferred embodiments of this invention are presented herein for the purpose of illustration and description only; it is not intended to be exhaustive or to be limited to the precise form disclosed.

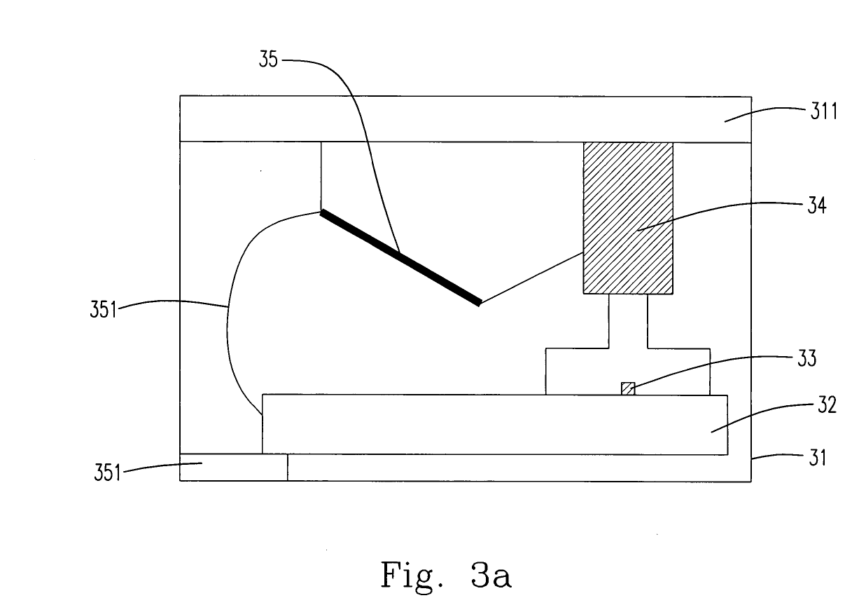

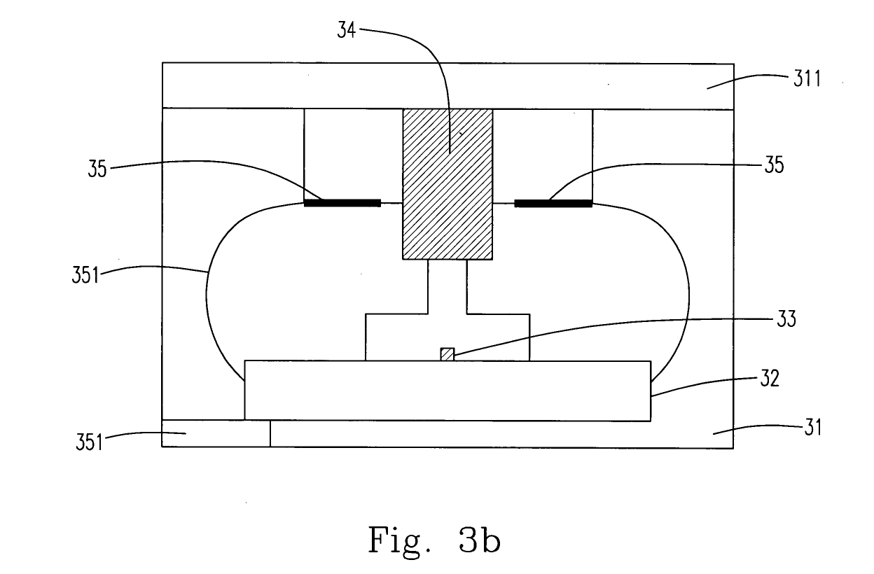

Please refer to FIG. 3(a) showing a light source module structure according to a preferred embodiment of the present invention. The light source module structure 3 includes a housing 31, a circuit board 32, a light-sensing element 33, a lens 34 and a light source apparatus 35. The housing 31 has a transparent surface 311 formed of glass or has an open surface instead of the transparent surface 311. The light source apparatus 35 is connected to the circuit board 32 via a flexible print circuit 351 as shown in FIG. 3(a) or via a connector. In addition, it is possible for the light source apparatus 35 to be disposed on another circuit board (not shown), and furthermore the circuit board having the light source apparatus 35 thereon is connected to the circuit board 32 via a flexible print circuit or a connector to control the light-emitting mechanism.

Specifically, the light source apparatus 35 is formed of at least one organic electro luminescent element according to the present invention. The organic electro luminescent element can be a small molecular organic light emitting diode integration, or can be a polymeric organic light emitting diode integration. In contrast to the conventional light emitting diode, the organic electro luminescent element is energy saving, easily fabricated and operated at wide range of temperature, and the organic electro luminescent element further has low cost, full color and a high reaction rate without viewing angles, so that it is optimal to form a scanner by using the organic luminescent element.

Please refer to FIG. 3(b). The light-sensing element 33 is disposed on the circuit board 32 and connected to the circuit board 32. The light-sensing element 33 can be one selected from a group consisting of a charge-coupled device, a complementary metal oxide semiconductor and an element having an optical to electronic converting property. When the scanner is operated to scan an object (not shown), the light emitted from the light source apparatus 35 is passing through the transparent surface 311 and then is reflected by the object. The reflected light is focused on the light-sensing element 33 by the lens 34, the light signal received by the light-sensing element 33 is transferred into electric signals by other electric components on the circuit board 32, and therefore an image is formed.

Since the appearance and size of a CIS module vary from applications and types, the design of the light source apparatus 35 formed of organic electro luminescent element is various. Please refer to FIG. 3(b) showing another arrangement of a light source apparatus 35. Certainly, FIGS. 3(a) and 3(b) illustrate the preferred embodiments of the present invention, but not limit the arrangement of the present invention. It means that the appearance, numbers and arrangement of the light source apparatus 35 can be modified as long as the distribution of the light emitted from the light source apparatus 35 is even.

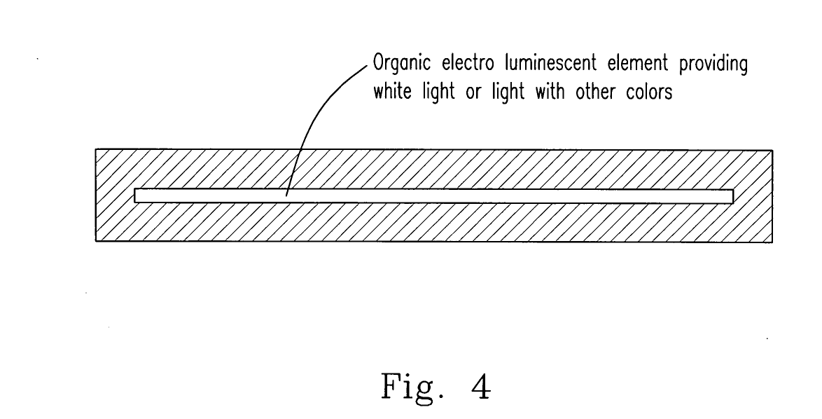

According to the present invention, the main structure of the light source module structure is described as above; however, types of the light source module structure formed of organic electro luminescent elements are not limited by above description. For example, referring to FIG. 4, the organic electro luminescent element of the light source apparatus is fabricated as a form of a bar for providing the monochromatic light in which the monochromatic light is white light or lights with other colors.

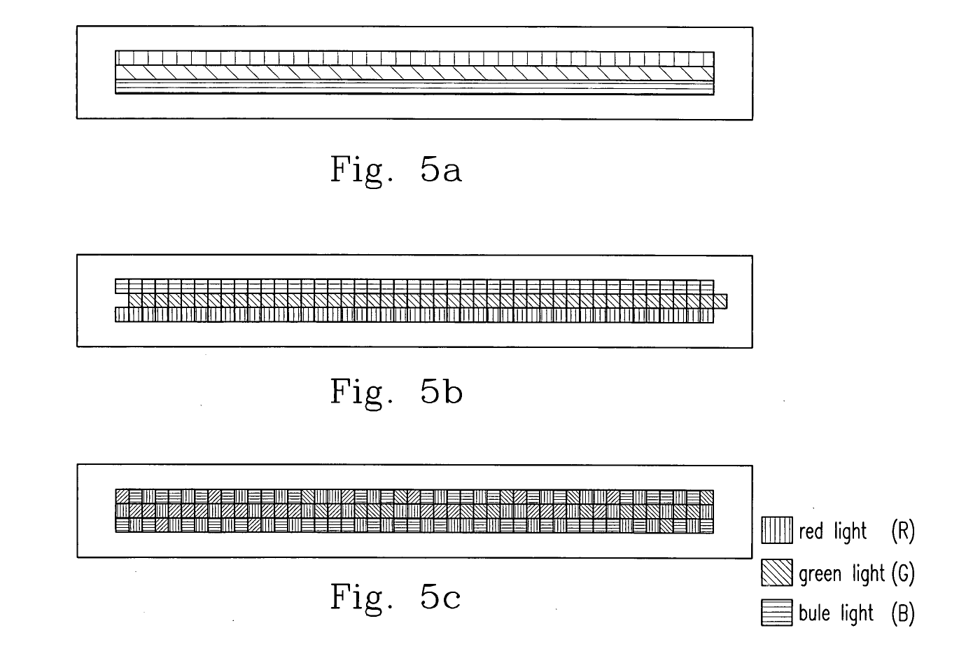

In addition, the light source apparatus formed of organic electro luminescent elements also can be designed for providing the light with primitive colors. Please refer to FIGS. 5(a)-5(c) showing pixel arrangements of an organic electro luminescent element providing a light with primitive colors. The organic electro luminescent elements for providing red light, green light and blue light can be fabricated as a form of a bar as shown in FIG. 5(a). Alternatively, the organic electro luminescent elements can be provided in a staggered arrangement as shown in FIGS. 5(b) and 5(c). Similarly, the pattern of the pixel can be a square, circle, hexagon, irregular shape or other random shape. The arrangement of the patterns can be modified. For example, the arrangement can be formed by the conventional tiling or array technologies.

In conclusion, the present invention provides an organic electro luminescent element as the main component of a light source structure for a CIS module of a scanner, a multi-function printer (MFP) or a copy machine, and in contrast to the conventional light emitting diodes, the present invention has many advantages as follows.

(1)The organic electro luminescent element is a plane light source which is arranged to fit the size of the CIS module, and each pixel has an equal distance to the object (reflecting surface), so that there is equal illumination at any point in a path from the light source via the object to the light-sensing element. Accordingly, the evenness of optical to electronic conversion of the pixels on a scanning line is achieved.

(2)The organic electro luminescent element can be fabricated as a form of a bar having pixels without intervals or as a form having pixels with a minimal intervals; the latter even has a minimal interval less than 40 micrometers.

(3) The reaction time of the light emitting diode is milliseconds; however, the reaction time of the organic electro luminescent element is microseconds. Accordingly, the present invention provides the light-sensing element having high efficiency.

(4)The substrate of the organic electro luminescent element can be glass, plastics, metals or flexible films, so that the organic electro luminescent element is very thin. Accordingly, the present invention not only provides a light source module structure for a scanner having a contact image sensor (CIS), but also reduce the thickness of the light source module structure to 0.2 millimeters.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A light source module structure for a CIS module of a scanner, a multi-function printer (MFP) or a copy machine, comprising:
a housing having a first circuit board therein;
a light-sensing element disposed on said first circuit board and electrically connected to said first circuit board;
a lens disposed in said housing and being parallel to said light-sensing element; and
at least one organic electro luminescent element integration disposed in said housing to provide a light source.

2. The light source module structure according to claim 1, wherein said organic electro luminescent element integration is a small molecular organic light emitting diode integration.

3. The light source module structure according to claim 1, wherein said organic electro luminescent element integration is a polymeric organic light emitting diode integration.

4. The light source module structure according to claim 1, wherein said housing further has an open surface for said light and said reflected light to pass therethrough.

5. The light source module structure according to claim 1, wherein said housing further has a transparent surface for said light and said reflected light to pass therethrough.

6. The light source module structure according to claim 5, wherein said transparent surface is formed of glass.

7. The light source module structure according to claim 1, wherein said light-sensing element is one selected from a group consisting of a charge-coupled device, a complementary metal oxide semiconductor and an element having an optical to electronic converting property.

8. The light source module structure according to claim 1, wherein said light source provided by said organic electro luminescent element integration is a monochromatic light.

9. The light source module structure according to claim 1, wherein said light source provided by said organic electro luminescent element integration is a light with primitive colors.

10. The light source module structure according to claim 1, wherein said light source provided by said organic electro luminescent element integration has a pixel pattern having a random shape and a random arrangement.

11. The light source module structure according to claim 1, wherein a plurality of organic electro luminescent element integrations are fabricated by a tiling technology to form a needed size.

12. The light source module structure according to claim 1, wherein a plurality of organic electro luminescent element integrations are fabricated by an array technology to form a needed size.

13. The light source module structure according to claim 1, wherein said organic electro luminescent element integration is connected to said first circuit board by one of a flexible print circuit and a connector.

14. The light source module structure according to claim 1, wherein said organic electro luminescent element integration is disposed on a second circuit board in said housing, and a light-emitting mechanism of said organic electro luminescent element integration is controlled by said second circuit board.

15. The light source module structure according to claim 12, wherein said second circuit board is connected to said first circuit board by one of a flexible print circuit and a connector.

16. The light source module structure according to claim 1, wherein a substrate of said organic electro luminescent element integration is one selected from a group consisting of glass, plastics, metals and flexible films.

17. A scanner, comprising:
a housing having a first circuit board therein;
a light-sensing element disposed on said first circuit board and electrically connected to said first circuit board;
a lens disposed in said housing and being parallel to said light-sensing element; and
at least one organic electro luminescent element integration disposed in said housing to provide a light source;
wherein light emitted from said light source is reflected by a scanned object to form a reflected light, and then said reflected light is focused on said light-sensing element via said lens.
